(19) United States
(12) Patent Application Publication
(10) Pub. No.: US 2003/0135739 A1
(43) Pub. Date: Jul. 17, 2003

(54) System and method for authentication

(76) Inventor: David N. Talton SR., Vienna, VA (US)

Correspondence Address: KENYON & KENYON, 1500 K STREET, N.W., SUITE 700, WASHINGTON, DC, 20005, US

(21) Appl. No.: 10/364,420

(22) Filed: Feb. 12, 2003

Related U.S. Application Data
(63) Continuation of application No. 10/133,342, filed on Apr. 29, 2002, now abandoned.
(63) Continuation of application No. 09/236,096, filed on Jan. 25, 1999, now abandoned.

(51) Int. Cl. H04L 9/00

(52) U.S. Cl. 713/185

(57) ABSTRACT

A system and method for authenticating an entity. A one time password is generated from an array populated with numbers by selecting an initial point in the array, implementing a jump procedure that specifies another location in the array, and then implementing a pick procedure that selects a set of numbers from the array. The set of numbers is stored as a one time password on a token. When the token is authenticated, the one time password is submitted to an Authorizer that stores the array, along with an identifier for the token. The Authorizer stores the initial point in the array from which the one time password was generated for the identified token. The Authorizer repeats the jump and pick procedures from the initial point for the identified token and produces a set of numbers. If the set of numbers so produced by the Authorizer matches the one time password from the token, then the token is successfully authenticated. Otherwise, the token is not successfully authenticated.

### CROSS-REFERENCE TO RELATED APPLICATIONS

This application claims the benefit of provisional application 60/072,145, filed on Jan. 22, 1998, and is a continuation of U.S. application Ser. No. 09/236,096, filed on Jan. 25, 1999, and U.S. application Ser. No. 10/133,342 filed Apr. 29, 2002, the disclosures of which, in their entirety, are hereby incorporated by reference.

### FIELD OF THE INVENTION

The field of the invention is authentication, and in particular the use of an array to authenticate a user.

### BACKGROUND

Authentication involves verifying the identity of an entity such as a client computer that is coupled to a network, a user operating a client computer, a static or running instance of software, etc.

Known systems include a password system. The entity and a verifier share a secret password. When the entity presents itself to the verifier, it does so along with the entity's identifier (the entity's “claimed identity”) and it's secret password. The verifier compares the password for the identified entity with the secret password stored at the verifier for that entity. If the password presented by the entity matches the secret password stored by the verifier, then the verifier determines that the claimed identity of the entity is valid. If there is no such match, then the verifier does not accept the claimed identity of the entity as valid. If the claimed identity is accepted, then the entity is “authenticated”, and granted whatever privileges attach thereto. For example, a bank customer (the user) sends his claimed identity along with his secret password to a bank computer (the verifier). If the user is successfully authenticated by the bank computer, then the customer is given access to his account information as it is stored in the bank's networked computers. Password systems are imperfect because the security of the system is destroyed if the secret password becomes known outside of the entity and the verifier. Numerous systems are known for compromising secret passwords by analysis of messages between an entity and verifier. Password distribution systems whereby a secret password generated by either the verifier or entity and then distributed to the other party are notoriously insecure. Also, passwords are vulnerable to theft or inadvertent disclosure.

Another known system includes asymmetric cryptographic authentication. In such a system (e.g., a public key cryptographic system such as that created by Rivest, Shamir and Adelman, or by Diffie and Hellman), a first cryptographic key is used to encrypt/decrypt data, while a related second key is needed to decrypt/encrypt the data. The first and second keys are generated by an entity. The first key is kept secret by the entity, while it makes the other publicly available. Any message that is encrypted by an entity using its secret “private” key can only be successfully decrypted using its corresponding “public” key. For example, an entity can encrypt the message “I am John Q. Smith” with its private key. Anyone wishing to verify that this message was indeed encrypted by John Q. Smith need only try to decrypt it with John Q. Smith's public key. If it can be so decrypted, then the message has been successfully authenticated. If not, the authenticity of the message is in doubt. Public key authentication systems are disadvantageously computation-intensive, and can absorb significant processor resources. Also, it is essential to maintain the integrity of the correspondence between any given public key and its source. That is, the security of the system can be destroyed if third parties can be convinced that the owner of a public key is a party other than its true owner. For example, suppose a party named Norman Jones successfully held himself out as John Q. Smith, and published a key that was held out as John Q. Smith's public key. In that case, the public key system would successfully authenticate a message purported to originate from John Q. Smith, when in fact it originated from Norman Jones.

### SUMMARY OF THE INVENTION

A system and method for authenticating an entity. A one time password is generated from an array populated with numbers by selecting an initial point in the array, implementing a jump procedure that specifies another location in the array, and then implementing a pick procedure that selects a set of numbers from the array. The set of numbers is stored as a one time password on a token. When the token is authenticated, the one time password is submitted to an Authorizer that stores the array, along with an identifier for the token. The Authorizer stores the initial point in the array from which the one time password was generated for the identified token. The Authorizer repeats the jump and pick procedures from the initial point for the identified token and produces a set of numbers. If the set of numbers so produced by the Authorizer matches the one time password from the token, then the token is successfully authenticated. Otherwise, the token is not successfully authenticated.

### BRIEF DESCRIPTION OF THE DRAWINGS

FIG. 1 shows the method in accordance with an embodiment of the present invention.

### DETAILED DESCRIPTION

In accordance with an embodiment of the present invention, elements of an array are populated with data. In one embodiment, the data is generated using a pseudo-random number generator. In another embodiment, the data is random. In another embodiment, the data is generated in accordance with a pattern. The array can be of any dimension, but a larger array will generally provide greater security than a smaller array. In order to operate most securely, at least one dimension of the array should be prime. Examples of array sizes include: 3×4, 234×11×89×4×6789, and 23458×23×3451.

In one embodiment of the present invention, one or more arrays are stored at an Authorizer. In one embodiment, the Authorizer is a computer comprising a processor and a memory, the memory being coupled to the processor. The memory stores instructions adapted to be executed by the processor to perform the steps of programming a token, as well as to perform the steps of authenticating a token, e.g., over a network. Memory and a token are devices capable of storing data. A token is typically more portable than the Authorizer computer. Examples of a token include a floppy disk, a smart card (including a processor), a magnetic strip, etc. In one embodiment, the memory and/or token includes random access memory. In another embodiment, the memory and/or token includes a hard disk, such as the Zip Disk manufactured by the Iomega Corporation of Roy, Utah.

In one embodiment of the present invention, the memory of the Authorizer computer stores information about the token, such as a token identifier that is unique to a particular token, or to a particular class of tokens. In one embodiment, the Authorizer includes a port adapted to be coupled to a network, the port coupled to the memory and the processor. In one embodiment, the Authorizer memory stores instructions adapted to be executed by the processor to perform the steps of authenticating a user, establishing an authentication window, and distributing cryptographic material as described below.

In one embodiment of the present invention, a token is programmed using the array as follows: At the Authorizer, a pointer is set to an initial starting point in the array. A “jump” procedure is implemented that moves the pointer from a jump start point in the array to a jump end point in the array. The jump start point can be the initial start point the first time the jump procedure is performed for a given initial start point. The jump procedure can be any procedure that moves in the array from a start point to an end point in a way that can be later reproduced. An example of a jump procedure is a vector that indicates a displacement from any starting point. For example, in a three-dimensional array, the vector 3X+2Y−4Z indicates a jump procedure that moves a pointer from a start point three elements in a positive direction in a first dimension X, two elements in positive direction in a second dimension Y, and four elements in a negative direction in a third dimension Z. The jump procedure need not be fixed from jump to jump. A jump procedure can change based on various factors. In one embodiment, the coefficients of a jump vector are mathematical functions that depend on the value of the element at the start point upon which the jump procedure operates. As the jump procedure is applied from successive start points, the coefficients of the vector will change as the value at the start point changes. An example of such a vector is: (int(324*S))X+18Y+(int(3.245/S))Z, where S is the value of the element at the start point, and the function int(W) truncates real number W to produce an integer. Even pseudo-random variables can specify all or part of a jump procedure, provided the pseudo-random variable can be reproduced (e.g., by recalling the appropriate seed value.)

After the jump procedure is performed, a “pick” procedure is performed. This procedure selects a set of array element values called a pick set. In one embodiment, the pick procedure selects array element values by moving the pointer. The pick procedure can be any procedure that moves a pointer in the array from a pick start point to a pick end point in a way that can be later reproduced. The examples of jump procedures discussed above can also be used for pick procedures. In one embodiment, the jump end point is the same as the pick start point. In one embodiment, the pick end point is the next jump start point.

In one embodiment of the present invention, an initial start point is selected. A jump procedure is implemented, moving a pointer from the initial start point (at this time the jump start point) to a jump end point. This jump end point is also the pick start point. A pick procedure is then implemented, and a set of array elements called a “pick set” are chosen and stored on a token. This is the first pick set. In one embodiment, a pick set is called a “One Time Password” (“OTP”). At the end of the pick procedure, the pointer is at the pick end point, which now becomes the new jump start point. In another embodiment, the new jump start point is offset from the pick end point.

The jump procedure is implemented to move the pointer to the next jump end point. In one embodiment, this is also the new pick start point. The pick procedure is implemented, producing a set of array elements that is recorded on the token, e.g., as the next OTP. This is the second pick set. This is repeated until the desired number of pick sets are recorded on the token. In one embodiment, the pick sets are encrypted on the token.

In accordance with an embodiment of the present invention, the token is distributed to a user. A token identifier is correlated with the initial start point from which the pick sets on the card were derived. The token identifier and the initial start point are stored at the Authorizer.

In one embodiment the pick set is encrypted on the token. When the user with the token desires to authenticate itself to the Authorizer, the user sends a user identifier (e.g., a user password) to the Authorizer. If the password is correct, the Authorizer sends key material to the user that is used to decrypt the pick sets on the token. In one embodiment, this is performed by having a portion of key material stored on the token. This portion of key material stored on the token can be protected by encrypting it such that it can only be decrypted using a secret personal identification number (PIN) known to the user. The key material received from the Authorizer is combined with the key material stored on the token to decrypt the pick sets.

The user sends the token identifier to the Authorizer, along with a pick set. In one embodiment, the first pick set on the token sent from the user to the Authorizer is the first jump start point, which is also the initial start point. In accordance with an embodiment of the present invention, the Authorizer proceeds to the initial start point that corresponds to the token identifier, and performs the jump and pick procedures to obtain a test pick set. The Authorizer compares the test pick set to the pick set provided by the user from the token. If they are the same, then the token (and, by implication in one embodiment, the user) is authenticated. When the user is authenticated, in one embodiment the Authorizer performs an authorized action. For example, in one embodiment, the authorized action is to provide cryptographic key material from the Authorizer to the user. In another embodiment, the Authorizer fetches information from a database and sends it to the user.

In one embodiment, the Authorizer stores a record of the last jump start point derived from the most recently provided pick set received from the user. This last jump start is correlated with the token identifier. When the next pick set is received from the user, the Authorizer starts from the last jump start derived form the most pick set most recently received from the user, jumps, picks a test pick set, and compares the test pick set with the pick set received from the user. If the two match, then the token and/or user is authenticated.

A pick set sent from the user may not be received by the Authorizer. For example, when the user sends a pick set through a network to the Authorizer, network problems may cause the pick set to be dropped or corrupted. The present invention advantageously provides a robustness feature called an authentication window that allows a user with a valid token to authenticate itself even when one or more pick sets are lost on the way from the user to the Authorizer. The authentication window in one embodiment is assigned an integer value, for example 10. When a received pick set does not match a test pick set, the jump and pick procedures are run to derive up to ten test pick sets from the array ahead of the current pick set. If one of these pick sets matches the received pick set, then an authorized action is performed, and the Authorizer stores the last jump start point derived from the pick set received from the user that matched the test pick set. In this way, a valid token is not rendered useless simply because one or more pick sets sent from the token to the Authorizer are not received at the Authorizer, or are received in a corrupted state. The size of the authentication window can advantageously be adjusted to accommodate the reliability of the transmission environment. For example, in stressed network conditions, the size of the window can be increased to allow for numerous faulty transmissions of pick sets from the user. In an efficient and reliable network, the size of the window can be decreased to improve security and reduce the number of tries available to a user without a valid token to attempt to become authenticated by the Authorizer.

In one embodiment, the present invention provides a method for securely distributing cryptographic key material. In one embodiment, the Authorizer stores a cryptographic key complement for each user in a set of users. A key complement is data which, when combined with other data (called cryptographic key base data), forms a complete cryptographic key useful for encrypting and/or decrypting data. Each user stores a key base. The key complement and key base alone are typically not useful for encrypting and/or decrypting data. Further, the key complement should not be easily derivable (or not at all derivable) from the key base, and vice versa. When each of the users in the set is authenticated by the Authorizer, the Authorizer distributes the appropriate key complement to each user. Each authenticated user combines its key base with the key complement received from the Authorizer to comprise a complete key. This key can be the same (symmetric to) the keys formed in like manner by the rest of the users in the set. These keys can be used to establish secure communications among the users in the set. In this way, an embodiment of the present invention advantageously provides a secure key distribution system. The key complement information can comprise symmetric keys or public keys. In one embodiment, a key complement for a particular user is (or is derived from) a pick set sent from the Authorizer to the user. The pick set can be derived from the same array used to authenticate the user, or from another array using an embodiment of the jump and pick method disclosed above.

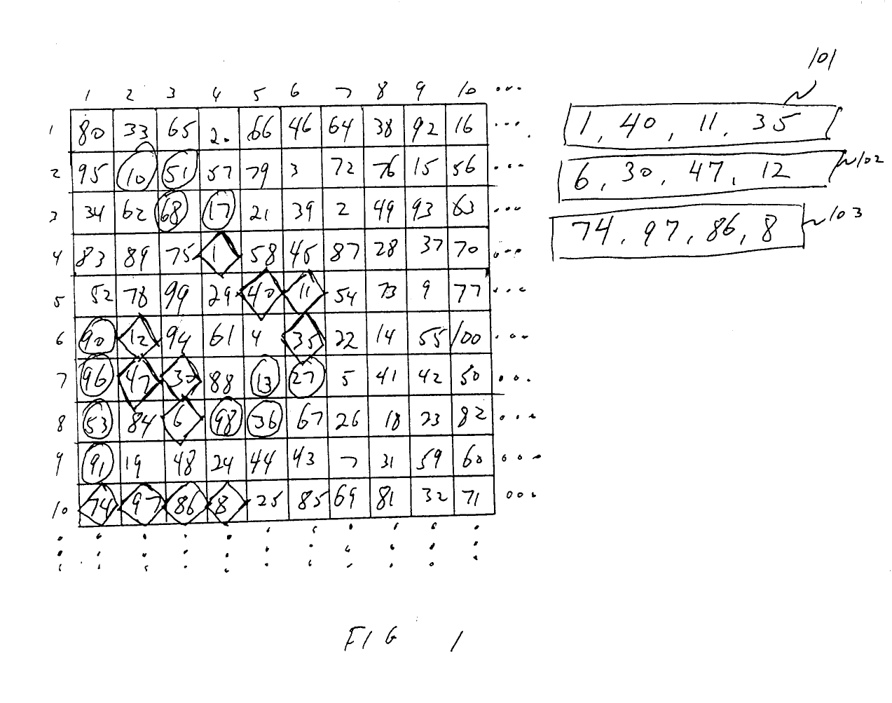

An embodiment of the present invention is shown in FIG. 1, which shows the upper left corner of an array whose dimensions are prime. An initial point is selected in the array at coordinate position (2,2) (the jump start point), as shown in FIG. 1. The jump procedure is implemented, shown as one step to the right (2,3), one step down (3,3) one more step to the right (3,4) and one step down to (4,4) (jump end point). The pick procedure is then implemented, picking numbers in the array with the pick start point the same as the jump end point (4,4). Thus, the first number in this pick set is 1, the array entry at (4,4). The pick procedure then moves the pointer down and over to (5,5) to the entry 40, then to (5,6) to entry 11, and then down to entry 35 at (6,6). Thus, the first pick set is 1, 40, 11, 35, and is shown as 101 in FIG. 1. In like fashion, the jump procedure is implemented again, skipping over array entries 27, 13, 36 and 98 as shown in FIG. 1. The pick procedure is then implemented again to obtain a second pick set, which is 6, 30, 47, 12, shown as 102. A jump procedure is implemented again, skipping over 90, 96, 53 and 91. A third pick set is generated: 74, 97, 86,8, shown as 103. In this fashion, entries are skipped and picked in accordance with an embodiment of the present invention. The pick sets can be stored on a token, along with a token identifier, e.g., a number akin to a serial number. The token identifier is also stored at the Authorizer, along with the initial point from which the pick sets were generated (here, (2,2). These are correlated at the Authorizer, i.e., stored as (token_serial_number, initial_point).

Although embodiments are specifically illustrated and described herein, it will be appreciated that modifications and variations of the present invention are covered by the above teachings and within the purview of the appended claims without departing from the spirit and intended scope of the invention.

What is claimed is:

1. A method for storing a One Time Password on a token, including:
a. implementing a jump procedure from a start jump point to an end jump point in an array populated with numbers;
b. implementing a pick procedure starting from a pick start point to a pick end point in the array to obtain a pick set; and
c. storing the pick set on the token.
